(19) United States
(12) Patent Application Publication
(10) Pub. No.: US 2019/0138958 A1
(43) Pub. Date: May 9, 2019

(54) CATEGORY IDENTIFIER PREDICTION

(71) Applicant: salesforce.com,inc., San Francisco, CA (US)

(72) Inventors: Divya Ranjit, San Francisco, CA (US); Ray Pendyck, Odessa, FL (US); Nick McDuffie, Dublin, CA (US); James Hatton, Odessa, FL (US)

(21) Appl. No.: 15/802,796

(22) Filed: Nov. 3, 2017

(51) Int. Cl. G06Q 10/06

(52) U.S. Cl. CPC G06Q 10/06311; G06Q 10/063114; G06Q 10/06315

(57) ABSTRACT

A system may predict a category identifier for a work item to improve inefficiencies and errors in assigning work items to particular teams or team members. The system may predict a category for the work item based on receiving a text description of the work item, an identifier associated with a team category, and an identifier associated with a product tag category. For example, a prediction model may be selected based upon any one or more of the received input, and the prediction model may predict the category identifier for the work item. Because the category identifier may be predicted based on the input received, a wide range of category identifiers may be predicted, resulting in a more streamlined and accurate system for assigning work items.

### FIELD OF TECHNOLOGY

The present disclosure relates generally to database systems and data processing, and more specifically to category identifier prediction.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

A user of a CRM application may use a system to create a work item to elevate a customer support investigation to the appropriate support team, for example. The user interface for the system may include a number of fields to manually enter data associated with the work item. For example, the user interface may include fields to select a team and a product related to the customer support investigation. The system may require that these fields be filled in before the system will create the work item. However, in some cases, an organization may have tens of thousands of teams or products to choose from. In such cases, the user may manually select a product or team, either randomly or with little guidance, so that the work item will be created and forwarded along to a support team. If the selected product or team was chosen incorrectly, then someone from the chosen team may have to notify the user that the selected team is not responsible for the particular problem, and the user may have to repeat the process of filling in the fields and submitting the work item. This procedure may introduce inefficiencies into the system, causing unnecessary transmissions and memory usage by the system.

### BRIEF DESCRIPTION OF THE DRAWINGS

FIGS. 1 through 4 illustrate examples of systems that support category identifier prediction in accordance with aspects of the present disclosure.

FIGS. 5 and 6 show block diagrams of a device that supports category identifier prediction in accordance with aspects of the present disclosure.

FIG. 7 illustrates a block diagram of a system that supports category identifier prediction in accordance with aspects of the present disclosure.

FIGS. 8 through 11 illustrate methods for category identifier prediction in accordance with aspects of the present disclosure.

### DETAILED DESCRIPTION

When a new work item (e.g., a task or an investigation) is created, the work item is generally assigned to a particular team or team member for completion. However, because work items are often based on one or more issues for which a user or customer needs a solution, a large quantity and variety of work items exist. Further, due to the large quantity and variety, organizations often employ numerous teams to assist in the completion of work items (e.g., tens of thousands of teams or products that teams are responsible for). Also, systems used for creating work items may require that certain fields are filled out (e.g., team or product fields) before the work item is created by the system. Thus, assigning a particular work item to the best-fit team or team member is often time consuming, and frequently results in work items being incorrectly assigned, which may result in additional signaling overhead and memory usage by the system due to the back-and-forth between teams and the re-assigning of work items. By receiving identifying information pertaining to a particular work item—or one or more identifiers associated with a team or product category—a category identifier for a particular task may be predicted by the system, resulting in a more streamlined and accurate work item assignment process, which may reduce the signaling overhead and resource usage by the system.

In a first example, a category identifier for a work item may be predicted. A text description of the user item—such as a description of an investigation, a bug, or a task—may be received via a user interface of a computing device. In some examples, an identifier associated with a team category and an identifier associated with a product tag category may also be received. Upon receiving the information at the user device, a prediction request may be transmitted to a prediction module. The request may, for example, include at least an indication of the text description of the work item. The prediction module may input the text description of the work item into at least one of a plurality of prediction models. In return, the prediction model may determine a predicted identifier associated with the product tag category. Stated alternatively, the prediction model may predict a category identifier for the work item. The prediction module may then transmit an indication of the one or more identifiers associated with the product tag category which, in some examples, may be displayed at the user interface of the computing device. In some examples, the prediction module may also transmit an indication of the confidence level associated with the predicted identifier.

In another example, a category identifier for a work item may be predicted by first receiving a text description of the user item, an identifier associated with a team category, and an identifier associated with a product tag category may also be received. Subsequently, for example, a prediction request may be transmitted to a prediction module that includes a prediction model identifier. The prediction model identifier may identify a particular prediction model (of a group of possible prediction models) for use in predicting the category identifier. The identifier may, for example, identify the prediction model based in part on the received identifier associated with the team category. The prediction module may then input the text description of the work item into identify one of a plurality of prediction models. In return, the prediction model may determine a predicted identifier associated with the product tag category. The prediction module may then transmit an indication of the one or more identifiers associated with the product tag category which, in some examples, may be displayed at the user interface of the computing device.

In yet another example, a category identifier for a work item may be predicted by first receiving a text description of the user item, an identifier associated with a team category, and an identifier associated with a product tag category may also be received. Subsequently, for example, a prediction request may be transmitted to a prediction module that includes the text description and the identifier associated with the team category. The prediction module may then input the text description of the work item and the identifier associated with the team category into one of a plurality of prediction models. In return, the prediction model may determine a predicted identifier associated with the product tag category. The prediction module may then transmit an indication of the one or more identifiers associated with the product tag category which, in some examples, may be displayed at the user interface of the computing device.

The system described above may support various computing devices, multiple prediction modules, and multiple prediction models. For example, one or more prediction models may exist for each team category. The system may also include mechanisms to assign a predicted identifier to a particular work item. In some cases, the system may support the transmission of the indication of the predicted identifiers based in part on a confidence level associated with the identifier. Additionally or alternatively, for example, the system may support predicting a category identifier for a work item when the text description of the work item is associated with an investigation, a bug, or a task.

Aspects of the disclosure are initially described in the context of an environment supporting an on-demand database service. Further aspects of the disclosure are described with respect to systems that support category identifier prediction, such as at a computing device. Aspects of the disclosure are further illustrated by and described with reference to apparatus diagrams, system diagrams, and flowcharts that relate to category identifier prediction.

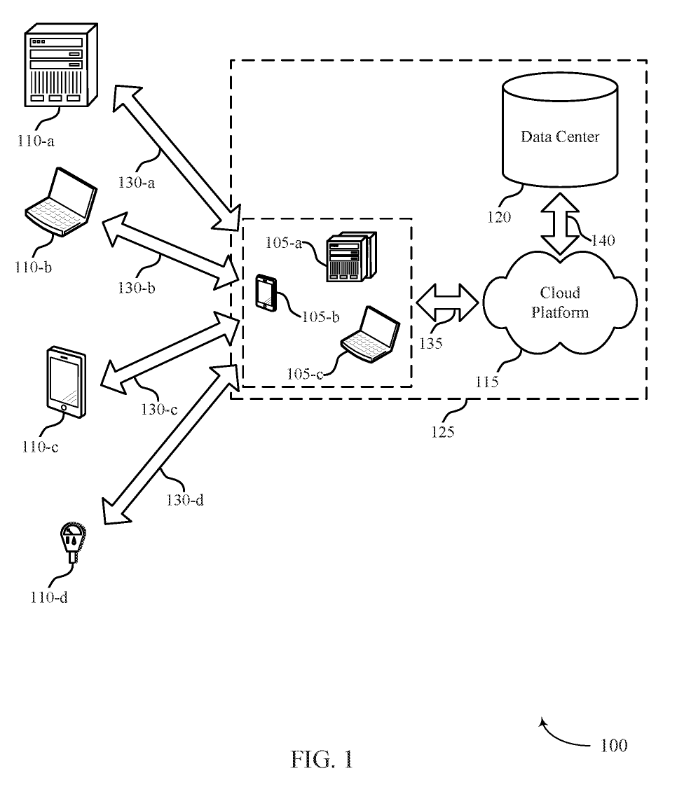

FIG. 1 illustrates an example of a system 100 for cloud computing that supports category identifier prediction in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The cloud clients 105 of subsystem 125 may be examples of one or more computing devices and data center 120 may be an example of or include, as a component, a server to which a cloud client 105 may attempt to request access from. For example, cloud client 105 may receive, via a user interface, a text description of a work item. The work item may be in response to a technical problem submitted by a customer via a contact 110. In some examples, cloud client 105 may also receive an identifier associated with a team category and an identifier associated with a product tag category. Upon receiving the input, the cloud client 105 may transmit a prediction request to a prediction module. In some examples, the prediction module may be a component of cloud client 105 and, in other cases, the prediction module may be a component of data center 120. In either instance, the prediction request may include at least an indication of the text description of the work item. In some examples, the prediction module may input at least the indication of the text description of the work item into a prediction model. The prediction model may be one of a plurality of prediction modules.

The prediction module may, in return, determine one or more predicted identifiers associated with the product tag category. In some examples, the one or more predicted identifiers associated with the product tag category may be different than the received identifier associated with the product tag category. The prediction module may then transmit an indication of the one or more predicted identifiers associated with the product tag category. For example, the prediction module may be a component of data center 120 and thus the one or more predicted identifiers may be transmitted from the prediction module of data center 120 to the cloud client 105. The cloud client may then—via the user interface—display the one or more predicted identifiers.

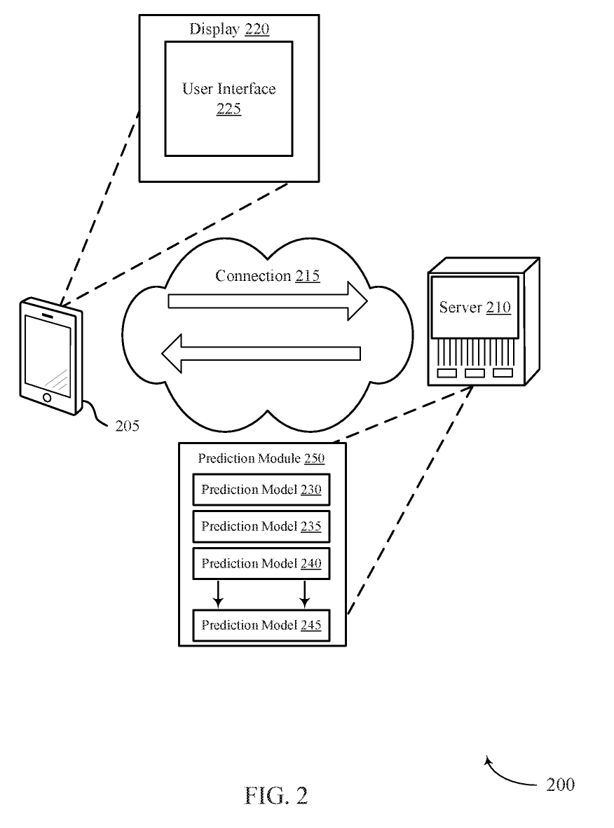

FIG. 2 illustrates an example of a system 200 that supports category identifier prediction in accordance with various aspects of the present disclosure. The system 200 may include a computing device 205, which may be an example of a cloud client 105 as described with reference to FIG. 1; and a server 210, which may be an example of the data center 120 as described with reference to FIG. 1. In some cases, the server 210 may be an example of components of a data center 120, a cloud platform 115, or some combination of these, as described with reference to FIG. 1. The system 200 may also include one or more connections, such as connection 215. In some examples, the computing device 205 may include display 220 and user interface 225. The server 210 may include a plurality of prediction models—including prediction models 230, 235, 240, and 245, as well as a prediction module 250.

In some examples, the computing device 205 may display a user interface 225 via a display 220. The user interface 225 may contain one or more fields to receive user input. For example, the fields may receive user input that includes a text description of the work item, an identifier associated with a team category, and an identifier associated with a product tag category, among others. In some examples, the text description of the work item may be associated with one or more of an investigation, a bug, or a task. In other examples, the identifier associated with the product tag category may include one or more of a keyword, a key phrase, or a category associated with a plurality of work items. Additionally or alternatively, for example, a user may input each of the text description of the work item, the identifier associated with a team category, and the identifier associated with a product tag category.

Upon receiving the user input, the user device may transmit a prediction request to a prediction module 250. The prediction module 250 may be a component of server 210, for example, and the prediction request may be transmitted via connection 215. In some examples, the prediction request may include at least in indication of the text description of the work item. In other examples, the prediction request may include any combination of the text description of the work item, the identifier associated with a team category, and the identifier associated with a product tag category.

The prediction module 250, upon receiving the prediction request, may input at least the indication of the text description of the work item into a prediction model of a plurality of prediction models (e.g., prediction models 230, 235, 240, and 245). The prediction model may facilitate the prediction of the category identifier of the work item. In some examples, the prediction model may be or contain an algorithm, an artificial intelligence (AI) system, a machine learning algorithm, or some similar data model. Each prediction model may have been created using a training set of data with the text description of the work item as an input or a combination of the text description and some other inputs such as the identifier associated with the team category and the identifier associated with the product tag category. Multiple prediction models (e.g., prediction models 230, 235, 240, and 245) may exist due to the manner in which the training set of data was compiled. Thus the training set of data used to create prediction model 230 may differ from the training set of data used to create prediction model 235. For example, the training set of data used to create prediction model 230 may have included only the text description of the work item as an input, and the set of data used to create prediction model 235 may have included the text description of the work item, the identifier associated with the team category, and the identifier associated with the product category as inputs.

In some examples, the prediction request may include a prediction model identifier, which may identify a particular prediction model. In some examples, each prediction model (e.g., prediction models 230, 235, 240, and 245) may pertain to an individual team. Meaning that the server 210 may store a large quantity of prediction models. Because each prediction model may pertain to an individual team, the prediction model identifier may identify a particular prediction model based at least in part on the received identifier associated with the team category.

In some examples, the user interface 225 may receive a confidence level associated with the team category. The indication of the prediction model identifier may be based, in part, on the received indication of confidence. Stated alternatively, a user may be unsure of a team to which a work product should be assigned. Thus, the user may assign a relatively low level of certainty to the identifier associated with the team category. The level of uncertainty—for example, from zero percent to one hundred percent—may be received via the user interface 225. This level of uncertainty may be provided to the prediction module 250, which may use the information in determining a correct prediction model.

In other examples, the prediction module 250 may input the identifier associated with the team category into the prediction model to facilitate the prediction of the category identifier. For example, the prediction model may utilize both of the a text description of the work item and an identifier associated with a team category. Thus the ultimate determination of the one or more predicted identifiers may be based at least in part on the identifier associated with the team category.

Upon inputting the indication of the text description of the work item into a determined prediction model, one or more predicted identifiers associated with the product tag category may be determined. For example, the determination may result from one or more operations conducted by the prediction model and may be based in part on the indication of the text description of the work item received via user interface 225 and transmitted to, for example, the prediction module 250 of server 210. In some examples, the one or more predicted identifiers associated with the product tag category may be different than the received identifier associated with the product tag category. Meaning that a user may input an identifier associated with a product tag category and the prediction module 250 may make a more-educated suggestion. Stated alternatively, a user may input a best guess as to the identifier associated with the product tag category, and the prediction module 250 may display a more-accurate, different, category identifier.

In some examples, the prediction module 250 may determine one or more predicted identifiers associated with the product tag category. This may be a result of a statistical analysis. For example, the prediction module 250 may associate a confidence level associated with each predicted identifier as to how likely the predicted identifier corresponds to the text description of the work item. The confidence level may indicate, to a user, a best category identifier. In some examples, the prediction model may determine a plurality of predicted identifiers associated with the product tag category, and each predicted identifier may be associated with a corresponding confidence level.

Once a prediction model has been determined, the prediction module 250 may transmit an indication of the one or more predicted identifiers associated with the product tag category to, for example, the computing device 205. The prediction module 250 may transmit the indication via connection 215. In other examples, the prediction module 250 may also transmit an indication of a confidence level associated with each of the one or more predicted identifiers associated with the product tag category. The transmission predicted identifiers and the associated confidence levels may be transmitted based in part the confidence level associated with each of the one or more predicted identifiers. Thus, in some examples, a threshold confidence level may exist. Meaning that if a particular predicted identifier is associated with a confidence level lower than the threshold value, the predicted identifier will not be transmitted to the computing device 205.

Upon receiving the indication, the computing device 205 may display—via display 220—the one or more predicted identifiers associated with the product tag category. In some examples, the computing device 205 may also display the indication of the confidence level associated with each of the one or more predicted identifiers associated with the product tag category. Additionally or alternatively, for example, a user may then assign one predicted identifier of the one or more predicted identifiers associated with the product tag to the work item. Thus, in an example, where a plurality of predicted identifiers may be displayed, a user may select one. The predicted identifier may then be assigned to the work item, which may then be assigned to the team associated with the predicted identifier.

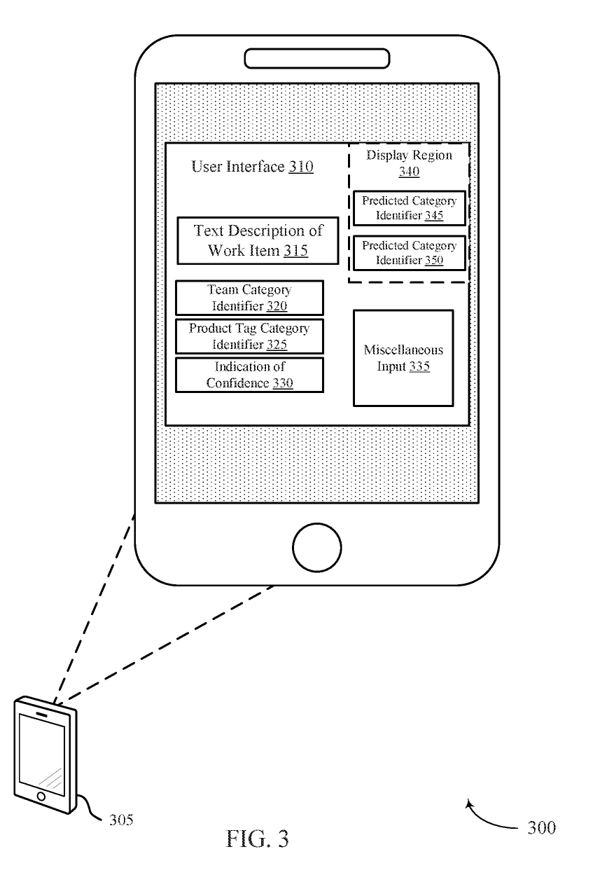

FIG. 3 illustrates an example of a system 300 that supports category identifier prediction in accordance with various aspects of the present disclosure. The system 300 may include a computing device 305, which may be an example of a computing device 205 as described with reference to FIG. 2. The computing device 305 of system 200 may include a user interface 310, which may be an example of the user interface 225 as described with reference to FIG. 2. The user interface 310 may include input fields 315, 320, 325, and 330, which may correspond to input fields for a text description of the work item, an identifier associated with a team category, an identifier associated with a product tag category, and an indication of confidence associated with the received identifier associated with the team category, respectively. The user interface 310 may also include a miscellaneous input field 335, and a predicted category identifier display region 340, which may include predicted category identifiers such as predicted category identifiers 345 and 350.

As described above, the computing device 305—via the user interface 310—may receive a text description of the work item 315, an identifier associated with a team category 320, and an identifier associated with a product tag category 325. Additionally or alternatively, for example, the computing device 305 may receive an indication of confidence associated with the received identifier associated with the team category 320. In some examples, the computing device 305 may also receive miscellaneous input that may facilitate the prediction of a category identifier for a work item. For example, the computing device 305 may receive, through miscellaneous input 335, one or more of a status indicator to indicate a status of the work item, a severity indicator to indicate the urgency of the work item, and a field to identify related work items, among others.

Upon receiving the a text description of the work item 315, an identifier associated with a team category 320, and an identifier associated with a product tag category 325 and, in some examples the indication of confidence associated with the received identifier associated with the team category 320, the computing device may transmit a prediction request to a prediction module, as described above. In some examples, the prediction request may include at least an indication of the text description of the work item 315 and, in other examples, may also include the identifier associated with the team category 320. Additionally or alternatively, for example, the prediction request may include the indication of confidence associated with the received identifier associated with the team category 320.

In some examples, after transmitting the prediction request to the prediction module, the prediction module may input at least the indication of the text description of the work item 315 into a prediction model of a plurality of prediction models. A specific prediction model may be selected, in part, based on any one of the text description of the work item 315, the identifier associated with the team category 320, and the indication of confidence associated with the received identifier associated with the team category 320. For example, if a user is more confident in selecting the identifier associated with the team category 320—indicated by a high level of confidence, for example—the identifier associated with the team category 320 may play a greater role in the selection of a prediction model. In another example, if a user is less confident in selecting the identifier associated with the team category 320, the identifier associated with the team category 320 may play a less role in the selection of a prediction model. In either instance, the prediction model may determine one or more predicted identifiers associated with the product tag category and, in some examples, transmit an indication of the one or more predicted identifiers associated with the product tag category and an indication of a confidence level associated with each of the one or more predicted identifiers associated with the product tag category to the computing device 305.

The computing device 305 may, upon receiving the transmission of the indication of the one or more predicted identifiers associated with the product tag category and the indication of a confidence level associated with each of the one or more predicted identifiers associated with the product tag category, display the one or more predicted identifiers and the associated confidence level at predicted category identifier display region 340. For example, predicted category identifier display region 340 may include one or more predicted identifiers associated with the product tag category and the indication of a confidence level associated with each. Each individual predicted identifier and associated confidence level may be displayed as, for example, predicted category identifiers 345 and 350. In some examples, a user may then assign one predicted identifier of, for example, predicted category identifiers 345 or 350 to the work item.

The user interface 310 of the computing device 305 that includes input fields for the identifier associated with a team category 320, the identifier associated with a product tag category 325, and the indication of confidence associated with the received identifier associated with the team category 320 may be merely an example. Thus, in other examples, the user interface 310 of the computing device may include input fields for any combination of the identifier associated with a team category 320, the identifier associated with a product tag category 325, and the indication of confidence associated with the received identifier associated with the team category 320 may be merely an example, or input fields in addition to those described above.

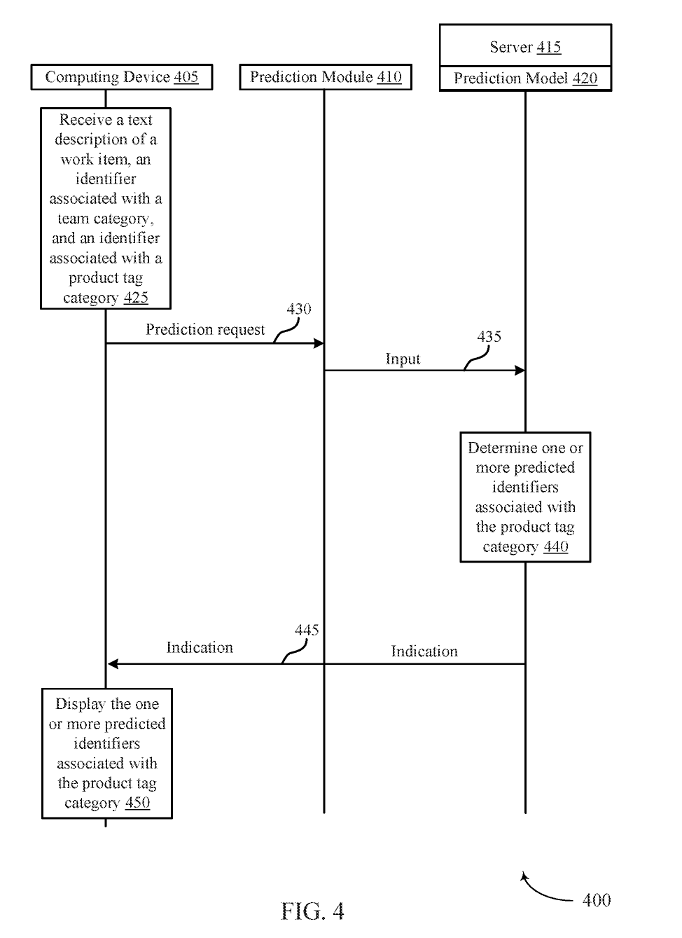

FIG. 4 illustrates an example of a system 400 that supports category identifier prediction in accordance with various aspects of the present disclosure. The system 400 may include a computing device 405, which may be an example of computing device 205 as described with reference to FIG. 2; a prediction module 410, which may be an example of a component of the computing device 405 or of the server 415, which may be an example of the server 210 as described with reference to FIG. 2; and a prediction model 420, which may be stored on the server 415.

System 400 may be an example of category identifier prediction for input received at the computing device 405. In some examples, the computing device 405 may receive, via a user interface (e.g., the user interface 225 as described with reference to FIG. 2), a text description of the work item, an identifier associated with a team category, and an identifier associated with a product tag category 425. At least the text description of the work item may be transmitted—through prediction request 430—to the prediction module 410. In other examples, the prediction request 430 may include the text description of the work item and the identifier associated with the team category. The prediction module 410 may be an internal component of the computing device 405 or, in some examples, may be a component of a server 415.

In either instance, the prediction module 410 may input at least the indication of the text description of the work item into a prediction model 420 of a plurality of prediction models. As described above, in some instances the prediction request 430 may include the text description of the work item and the identifier associated with the team category. Thus, in some examples, the prediction module 410 may input 435 the text description of the work item and the identifier associated with the team category into the prediction model 420. Also described above, the prediction module may be an internal component of the computing device 405 or may be a component of a server 415. In the instance that the prediction module 410 is part of the computing device 405, the computing device 405 may transmit the prediction request 430 internally to the prediction module 410 and the prediction module may establish a connection (e.g., a connection 215 as described with reference to FIG. 2) with the prediction model 420—stored on server 415—to input 435 the text description of the work item. In the instance that the prediction module 410 is part of server 415, the computing device 405 may establish a connection with the server 415. The computing device 405 may then transmit the prediction request 430—via the connection—to the prediction module 410, which may then input 435 the text description of the work item to the prediction model 420.

Upon inputting 430 the text description of the work item into the prediction model 420, one or more predicted one or more predicted identifiers associated with the product tag category may be determined 440. In some examples, the one or more predicted identifiers associated with the product tag category may be different than the received identifier associated with the product tag category. Upon determining the one or more predicted identifiers, the prediction model may transmit—by way of the prediction module 410—an indication 445 of the one or more predicted identifiers associated with the product tag category to the computing device 405. In some examples, the transmission of the indication 445 may also include an indication of a confidence level associated with each of the one or more predicted identifiers associated with the product tag category. The indication of the one or more predicted identifiers associated with the product tag category and the indication of the confidence level associated with each of the one or more predicted identifiers associated with the product tag category may then be displayed 450 at the computing device 405.

In one example, the computing device 405 may receive a text description of the work item, an identifier associated with a team category, and an identifier associated with a product tag category. For example, a user may assign the text description “McDonald's—Case 11236591—Social Studio—Social Accounts in McD Social Studio needs reauthorization,” the identifier associated with a team category “GUS,” and the identifier associated with the product tag category “GUS Functionality.” The text description of the work item, the identifier associated with a team category, and the identifier associated with a product tag category may be received at a user interface of the computing device 405.

Upon receiving the input, the computing device 405 may transmit a prediction request to a prediction module 410. The prediction request may include at least an indication of the text description of the work item—“McDonald's—Case 11236591—Social Studio—Social Accounts in McD Social Studio needs reauthorization.” Subsequently, for example, the prediction module 410 may input at least the indication of the text description of the work item into a prediction model of the plurality of prediction models. The prediction model may be an AI system. The prediction model may then determine, based at least in part on the indication of the text description of the work item, one or more predicted identifiers associated with the product tag category. For example, the predicted identifiers may be “R6_SociaAccounts” and “CM Workspaces,” which may correspond to two distinct teams. From this example, the one or more predicted identifiers—“R6_SociaAccounts” and “CM Workspaces”—are different than the input “GUS” identifier.

In some examples, the prediction module 410 may transmit an indication of the one or more predicted identifiers associated with the product tag category to the computing device 405. Additionally or alternatively, for example, the prediction module may also transmit an indication of a confidence level associated with each of the one or more predicted identifiers associated with the product tag category. For example, the prediction module 410 may transmit the predicted “R6_SociaAccounts,” which may be associated a confidence level of 56.861% and the predicted identifier “CM Workspace” which may be associated with a confidence level of 24.185%. The associated confidence levels may indicate a probability to which the AI system believes the tags are correct. In this example, each of the identifiers associated with the product tag category and the corresponding confidence levels may be displayed, at a user interface, of the computing device 405.

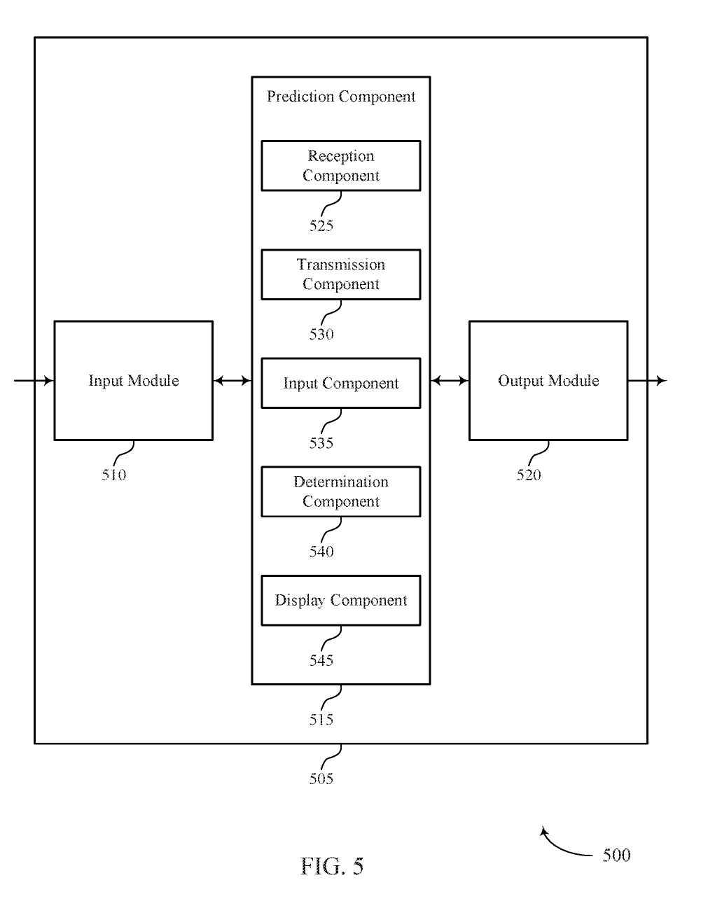

FIG. 5 shows a block diagram 500 of an apparatus 505 that supports category identifier prediction in accordance with aspects of the present disclosure. Apparatus 505 may include input module 510, prediction component 515, and output module 520. Apparatus 505 may also include a processor. Each of these components may be in communication with one another (e.g., via one or more buses). In some cases, apparatus 505 may be an example of a user terminal, a database server, or a system containing multiple computing devices.

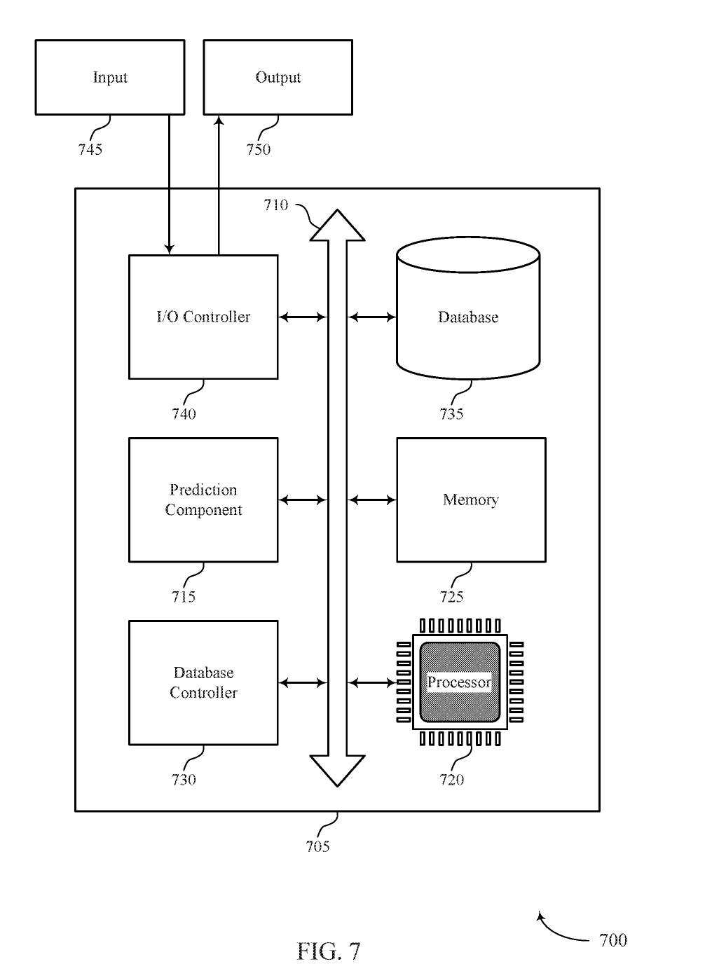

Prediction component 515 may be an example of aspects of the prediction component 715 described with reference to FIG. 7. Prediction component 515 and/or at least some of its various sub-components may be implemented in hardware, software executed by a processor, firmware, or any combination thereof. If implemented in software executed by a processor, the functions of the prediction component 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The prediction component 515 and/or at least some of its various sub-components may be physically located at various positions, including being distributed such that portions of functions are implemented at different physical locations by one or more physical devices. In some examples, prediction component 515 and/or at least some of its various sub-components may be a separate and distinct component in accordance with various aspects of the present disclosure. In other examples, prediction component 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Prediction component 515 may also include reception component 525, transmission component 530, input component 535, determination component 540, and display component 545.

Reception component 525 may receive, via a user interface of a computing device, a text description of the work item, an identifier associated with a team category, and an identifier associated with a product tag category. In other examples, reception component 525 may receive, via the user interface of the computing device, an indication of confidence associated with the received identifier associated with the team category, where indicating the prediction model identifier is based on the received indication of confidence. In some cases, the text description of the work item may be associated with one or more of an investigation, a bug, or a task. In other cases, the identifier associated with the product tag category may include one or more of a keyword, a key phrase, or a category associated with a set of work items.

Transmission component 530 may transmit a prediction request to a prediction module, where the prediction request includes at least an indication of the text description of the work item. In some examples, transmission component 530 may transmit, by the prediction module, an indication of the one or more predicted identifiers associated with the product tag category and an indication of a confidence level associated with each of the one or more predicted identifiers associated with the product tag category. In other examples, transmission component 530 may transmit the indication of the one or more predicted identifiers associated with the product tag category based on the confidence level associated with each of the one or more predicted identifiers. In some cases, the prediction request may include the identifier associated with the team category.

Input component 535 may input, by the prediction module, at least the indication of the text description of the work item into a prediction model of a set of prediction models. In other examples, input component 535 may input, by the prediction module, the identifier associated with the team category, where determining the one or more predicted identifiers is based on the identifier associated with the team category.

Determination component 540 may determine, from the prediction model and based on the indication of the text description of the work item, one or more predicted identifiers associated with the product tag category, where the one or more predicted identifiers associated with the product tag category are different than the received identifier associated with the product tag category.

Display component 545 may display, at the user interface of the computing device, the one or more predicted identifiers associated with the product tag category and the indication of the confidence level associated with each of the one or more predicted identifiers associated with the product tag category.

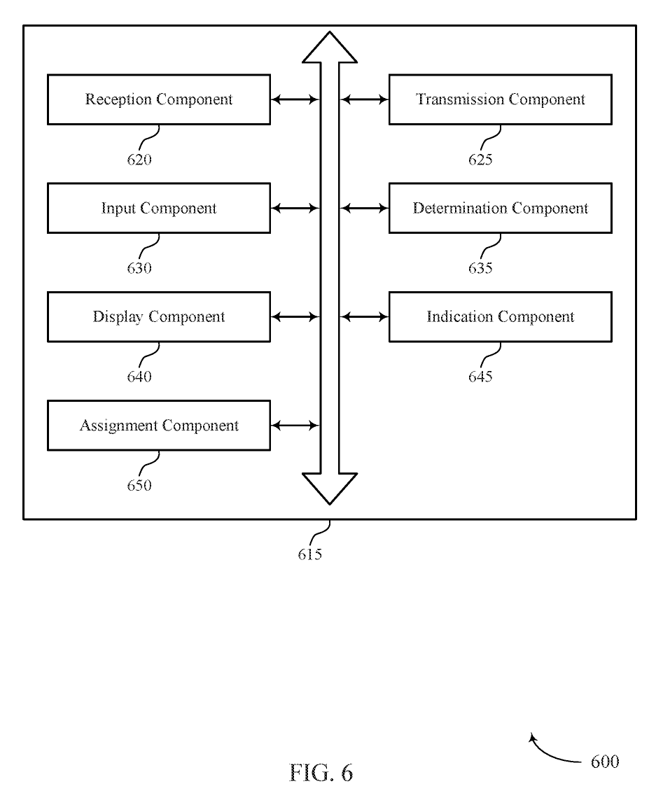

FIG. 6 shows a block diagram 600 of a prediction component 615 that supports category identifier prediction in accordance with aspects of the present disclosure. The prediction component 615 may be an example of aspects of a prediction component 715 described with reference to FIGS. 4, 5, and 7. The prediction component 615 may include reception component 620, transmission component 625, input component 630, determination component 635, display component 640, indication component 645, and assignment component 650. Each of these modules may communicate, directly or indirectly, with one another (e.g., via one or more buses).

Reception component 620 may receive, via a user interface of a computing device, a text description of the work item, an identifier associated with a team category, and an identifier associated with a product tag category. In some examples, reception component 620 may receive, via the user interface of the computing device, an indication of confidence associated with the received identifier associated with the team category, where indicating the prediction model identifier is based on the received indication of confidence. In some cases, the text description of the work item may be associated with one or more of an investigation, a bug, or a task. In some cases, the identifier associated with the product tag category may include one or more of a keyword, a key phrase, or a category associated with a set of work items.

Transmission component 625 may transmit a prediction request to a prediction module, where the prediction request includes at least an indication of the text description of the work item. In some examples, transmission component 625 may transmit, by the prediction module, an indication of the one or more predicted identifiers associated with the product tag category and an indication of a confidence level associated with each of the one or more predicted identifiers associated with the product tag category. In other examples, transmission component 625 may transmit the indication of the one or more predicted identifiers associated with the product tag category based on the confidence level associated with each of the one or more predicted identifiers. In some cases, the prediction request may include the identifier associated with the team category.

Input component 630 may input, by the prediction module, at least the indication of the text description of the work item into a prediction model of a set of prediction models. In some examples, input component 630 may input, by the prediction module, the identifier associated with the team category, where determining the one or more predicted identifiers is based on the identifier associated with the team category.

Determination component 635 may determine, from the prediction model and based on the indication of the text description of the work item, one or more predicted identifiers associated with the product tag category, where the one or more predicted identifiers associated with the product tag category are different than the received identifier associated with the product tag category.

Display component 640 may display, at the user interface of the computing device, the one or more predicted identifiers associated with the product tag category and the indication of the confidence level associated with each of the one or more predicted identifiers associated with the product tag category.

Indication component 645 may indicate a prediction model identifier in the prediction request, where the prediction model identifier identifies a particular prediction model from the set of prediction models. In some cases, the prediction model identifier may identify a particular prediction model based on the received identifier associated with the team category. In some cases, each of the set of prediction models may be associated with a different identifier associated with the team category.

Assignment component 650 may assign, at the user interface of the computing device, one predicted identifier of the one or more predicted identifiers associated with the product tag category to the work item.

FIG. 7 shows a diagram of a system 700 including a device 705 that supports category identifier prediction in accordance with aspects of the present disclosure. Device 705 may be an example of or include the components of computing device 205 as described above, e.g., with reference to FIG. 2. Device 705 may include components for bi-directional data communications including components for transmitting and receiving communications, including prediction component 715, processor 720, memory 725, database controller 730, database 735, and I/O controller 740. These components may be in electronic communication via one or more buses (e.g., bus 710).

Processor 720 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 720 may be configured to operate a memory array using a memory controller. In other cases, a memory controller may be integrated into processor 720. Processor 720 may be configured to execute computer-readable instructions stored in a memory to perform various functions (e.g., functions or tasks supporting category identifier prediction).

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a basic input/output system (BIOS) which may control basic hardware or software operation such as the interaction with peripheral components or devices.

Database controller 730 may manage data storage and processing in database 735. In some cases, a user may interact with database controller 730. In other cases, database controller 730 may operate automatically without user interaction.

Database 735 may be an example of a single database, a distributed database, multiple distributed databases, or an emergency backup database.

I/O controller 740 may manage input and output signals for device 705. I/O controller 740 may also manage peripherals not integrated into device 705. In some cases, I/O controller 740 may represent a physical connection or port to an external peripheral. In some cases, I/O controller 740 may utilize an operating system such as iOS®, ANDROID®, MS-DOS®, MS-WINDOWS®, OS/2®, UNIX®, LINUX®, or another known operating system. In other cases, I/O controller 740 may represent or interact with a modem, a keyboard, a mouse, a touchscreen, or a similar device. In some cases, I/O controller 740 may be implemented as part of a processor. In some cases, a user may interact with device 705 via I/O controller 740 or via hardware components controlled by I/O controller 740.

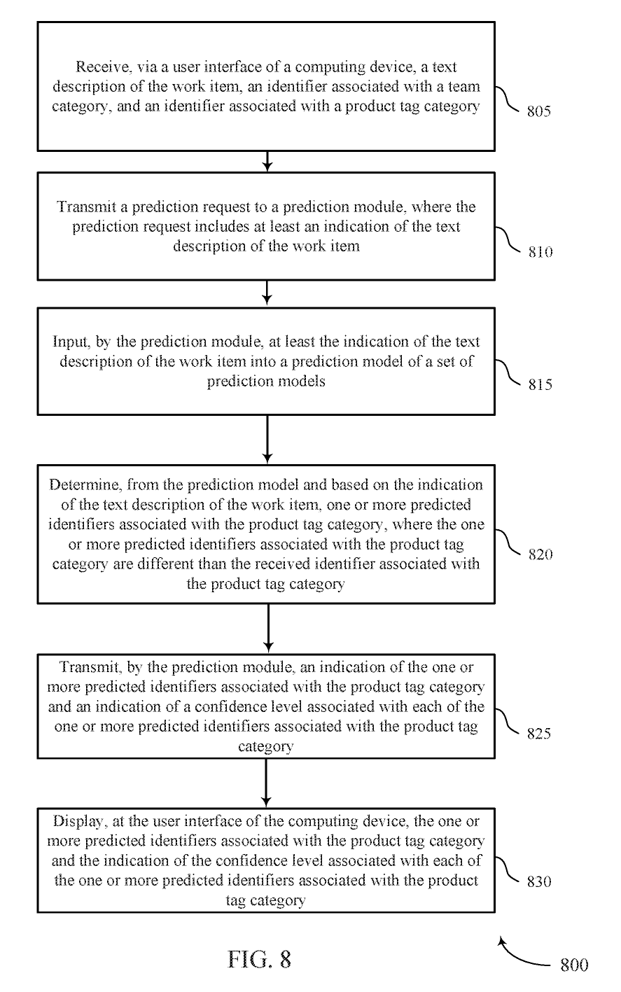

FIG. 8 shows a flowchart illustrating a method 800 for category identifier prediction in accordance with aspects of the present disclosure. The operations of method 800 may be implemented by a computing device (e.g., computing device 205 as described with reference to FIG. 2) or its components as described herein. For example, the operations of method 800 may be performed by a prediction component as described with reference to FIGS. 5 through 7. In some examples, a computing device may execute a set of codes to control the functional elements of the device to perform the functions described below. Additionally or alternatively, the computing device may perform aspects of the functions described below using special-purpose hardware.

At 805 the computing device may receive, via a user interface of a computing device, a text description of the work item, an identifier associated with a team category, and an identifier associated with a product tag category. The operations of 805 may be performed according to the methods described herein. In certain examples, aspects of the operations of 805 may be performed by a reception component as described with reference to FIGS. 5 through 7.

At 810 the computing device may transmit a prediction request to a prediction module, wherein the prediction request comprises at least an indication of the text description of the work item. The operations of 810 may be performed according to the methods described herein. In certain examples, aspects of the operations of 810 may be performed by a transmission component as described with reference to FIGS. 5 through 7.

At 815 the computing device may input, by the prediction module, at least the indication of the text description of the work item into a prediction model of a plurality of prediction models. The operations of 815 may be performed according to the methods described herein. In certain examples, aspects of the operations of 815 may be performed by a input component as described with reference to FIGS. 5 through 7.

At 820 the computing device may determine, from the prediction model and based at least in part on the indication of the text description of the work item, one or more predicted identifiers associated with the product tag category, wherein the one or more predicted identifiers associated with the product tag category are different than the received identifier associated with the product tag category. The operations of 820 may be performed according to the methods described herein. In certain examples, aspects of the operations of 820 may be performed by a determination component as described with reference to FIGS. 5 through 7.

At 825 the computing device may transmit, by the prediction module, an indication of the one or more predicted identifiers associated with the product tag category and an indication of a confidence level associated with each of the one or more predicted identifiers associated with the product tag category. The operations of 825 may be performed according to the methods described herein. In certain examples, aspects of the operations of 825 may be performed by a transmission component as described with reference to FIGS. 5 through 7.

At 830 the computing device may display, at the user interface of the computing device, the one or more predicted identifiers associated with the product tag category and the indication of the confidence level associated with each of the one or more predicted identifiers associated with the product tag category. The operations of 830 may be performed according to the methods described herein. In certain examples, aspects of the operations of 830 may be performed by a display component as described with reference to FIGS. 5 through 7.

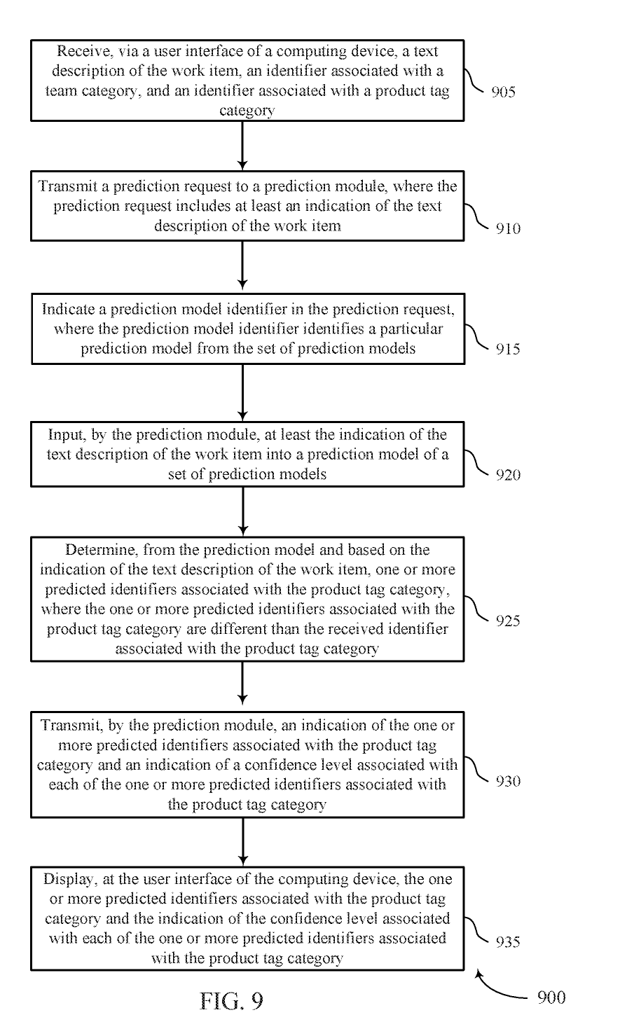

FIG. 9 shows a flowchart illustrating a method 900 for category identifier prediction in accordance with aspects of the present disclosure. The operations of method 900 may be implemented by a computing device (e.g., computing device 205 as described with reference to FIG. 2) or its components as described herein. For example, the operations of method 900 may be performed by a prediction component as described with reference to FIGS. 5 through 7. In some examples, a computing device may execute a set of codes to control the functional elements of the device to perform the functions described below. Additionally or alternatively, the computing device may perform aspects of the functions described below using special-purpose hardware.

At 905 the computing device may receive, via a user interface of a computing device, a text description of the work item, an identifier associated with a team category, and an identifier associated with a product tag category. The operations of 905 may be performed according to the methods described herein. In certain examples, aspects of the operations of 905 may be performed by a reception component as described with reference to FIGS. 5 through 7.

At 910 the computing device may transmit a prediction request to a prediction module, wherein the prediction request comprises at least an indication of the text description of the work item. The operations of 910 may be performed according to the methods described herein. In certain examples, aspects of the operations of 910 may be performed by a transmission component as described with reference to FIGS. 5 through 7.

At 915 the computing device may indicate a prediction model identifier in the prediction request, wherein the prediction model identifier identifies a particular prediction model from the plurality of prediction models. The operations of 915 may be performed according to the methods described herein. In certain examples, aspects of the operations of 915 may be performed by an indication component as described with reference to FIGS. 5 through 7.

At 920 the computing device may input, by the prediction module, at least the indication of the text description of the work item into a prediction model of a plurality of prediction models. The operations of 920 may be performed according to the methods described herein. In certain examples, aspects of the operations of 920 may be performed by a input component as described with reference to FIGS. 5 through 7.

At 925 the computing device may determine, from the prediction model and based at least in part on the indication of the text description of the work item, one or more predicted identifiers associated with the product tag category, wherein the one or more predicted identifiers associated with the product tag category are different than the received identifier associated with the product tag category. The operations of 925 may be performed according to the methods described herein. In certain examples, aspects of the operations of 925 may be performed by a determination component as described with reference to FIGS. 5 through 7.

At 930 the computing device may transmit, by the prediction module, an indication of the one or more predicted identifiers associated with the product tag category and an indication of a confidence level associated with each of the one or more predicted identifiers associated with the product tag category. The operations of 930 may be performed according to the methods described herein. In certain examples, aspects of the operations of 930 may be performed by a transmission component as described with reference to FIGS. 5 through 7.

At 935 the computing device may display, at the user interface of the computing device, the one or more predicted identifiers associated with the product tag category and the indication of the confidence level associated with each of the one or more predicted identifiers associated with the product tag category. The operations of 935 may be performed according to the methods described herein. In certain examples, aspects of the operations of 935 may be performed by a display component as described with reference to FIGS. 5 through 7.

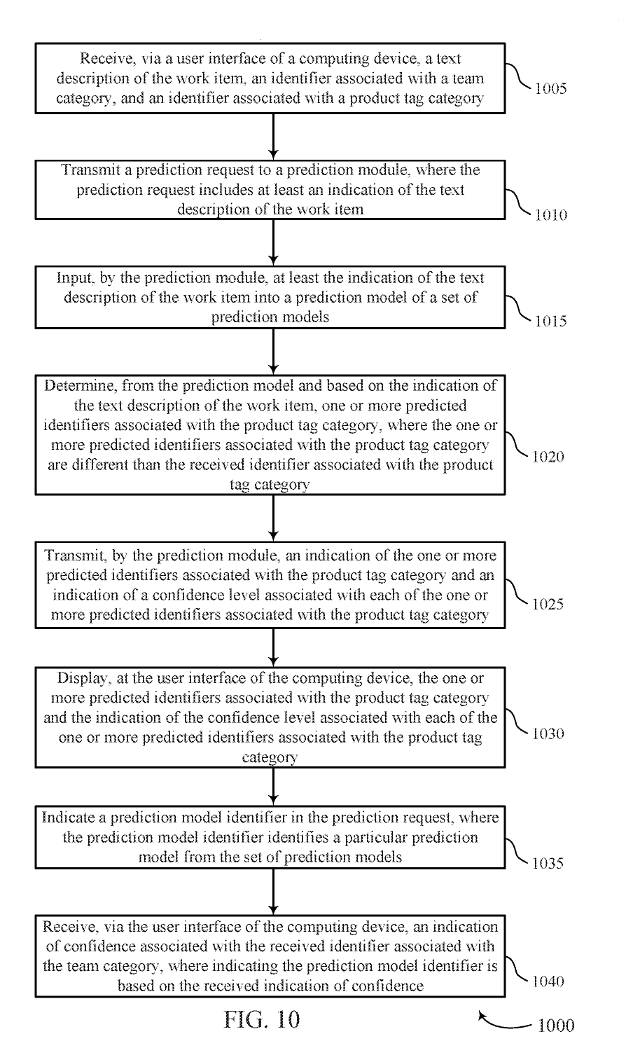

FIG. 10 shows a flowchart illustrating a method 1000 for category identifier prediction in accordance with aspects of the present disclosure. The operations of method 1000 may be implemented by a computing device (e.g., computing device 205 as described with reference to FIG. 2) or its components as described herein. For example, the operations of method 1000 may be performed by a prediction component as described with reference to FIGS. 5 through 7. In some examples, a computing device may execute a set of codes to control the functional elements of the device to perform the functions described below. Additionally or alternatively, the computing device may perform aspects of the functions described below using special-purpose hardware.

At 1005 the computing device may receive, via a user interface of a computing device, a text description of the work item, an identifier associated with a team category, and an identifier associated with a product tag category. The operations of 1005 may be performed according to the methods described herein. In certain examples, aspects of the operations of 1005 may be performed by a reception component as described with reference to FIGS. 5 through 7.

At 1010 the computing device may transmit a prediction request to a prediction module, wherein the prediction request comprises at least an indication of the text description of the work item. The operations of 1010 may be performed according to the methods described herein. In certain examples, aspects of the operations of 1010 may be performed by a transmission component as described with reference to FIGS. 5 through 7.

At 1015 the computing device may input, by the prediction module, at least the indication of the text description of the work item into a prediction model of a plurality of prediction models. The operations of 1015 may be performed according to the methods described herein. In certain examples, aspects of the operations of 1015 may be performed by a input component as described with reference to FIGS. 5 through 7.

At 1020 the computing device may determine, from the prediction model and based at least in part on the indication of the text description of the work item, one or more predicted identifiers associated with the product tag category, wherein the one or more predicted identifiers associated with the product tag category are different than the received identifier associated with the product tag category. The operations of 1020 may be performed according to the methods described herein. In certain examples, aspects of the operations of 1020 may be performed by a determination component as described with reference to FIGS. 5 through 7.

At 1025 the computing device may transmit, by the prediction module, an indication of the one or more predicted identifiers associated with the product tag category and an indication of a confidence level associated with each of the one or more predicted identifiers associated with the product tag category. The operations of 1025 may be performed according to the methods described herein. In certain examples, aspects of the operations of 1025 may be performed by a transmission component as described with reference to FIGS. 5 through 7.

At 1030 the computing device may display, at the user interface of the computing device, the one or more predicted identifiers associated with the product tag category and the indication of the confidence level associated with each of the one or more predicted identifiers associated with the product tag category. The operations of 1030 may be performed according to the methods described herein. In certain examples, aspects of the operations of 1030 may be performed by a display component as described with reference to FIGS. 5 through 7.

At 1035 the computing device may indicate a prediction model identifier in the prediction request, wherein the prediction model identifier identifies a particular prediction model from the plurality of prediction models. The operations of 1035 may be performed according to the methods described herein. In certain examples, aspects of the operations of 1035 may be performed by an indication component as described with reference to FIGS. 5 through 7.

At 1040 the computing device may receive, via the user interface of the computing device, an indication of confidence associated with the received identifier associated with the team category, wherein indicating the prediction model identifier is based at least in part on the received indication of confidence. The operations of 1040 may be performed according to the methods described herein. In certain examples, aspects of the operations of 1040 may be performed by a reception component as described with reference to FIGS. 5 through 7.

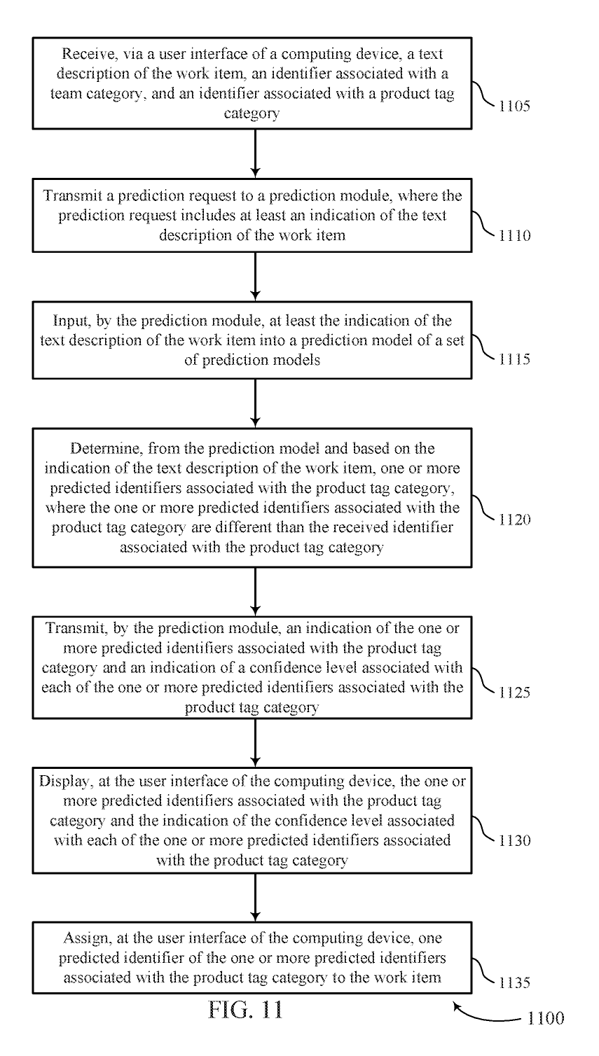

FIG. 11 shows a flowchart illustrating a method 1100 for category identifier prediction in accordance with aspects of the present disclosure. The operations of method 1100 may be implemented by a computing device (e.g., computing device 205 as described with reference to FIG. 2) or its components as described herein. For example, the operations of method 1100 may be performed by a prediction component as described with reference to FIGS. 5 through 7. In some examples, a computing device may execute a set of codes to control the functional elements of the device to perform the functions described below. Additionally or alternatively, the computing device may perform aspects of the functions described below using special-purpose hardware.

At 1105 the computing device may receive, via a user interface of a computing device, a text description of the work item, an identifier associated with a team category, and an identifier associated with a product tag category. The operations of 1105 may be performed according to the methods described herein. In certain examples, aspects of the operations of 1105 may be performed by a reception component as described with reference to FIGS. 5 through 7.

At 1110 the computing device may transmit a prediction request to a prediction module, wherein the prediction request comprises at least an indication of the text description of the work item. The operations of 1110 may be performed according to the methods described herein. In certain examples, aspects of the operations of 1110 may be performed by a transmission component as described with reference to FIGS. 5 through 7.

At 1115 the computing device may input, by the prediction module, at least the indication of the text description of the work item into a prediction model of a plurality of prediction models. The operations of 1115 may be performed according to the methods described herein. In certain examples, aspects of the operations of 1115 may be performed by a input component as described with reference to FIGS. 5 through 7.

At 1120 the computing device may determine, from the prediction model and based at least in part on the indication of the text description of the work item, one or more predicted identifiers associated with the product tag category, wherein the one or more predicted identifiers associated with the product tag category are different than the received identifier associated with the product tag category. The operations of 1120 may be performed according to the methods described herein. In certain examples, aspects of the operations of 1120 may be performed by a determination component as described with reference to FIGS. 5 through 7.

At 1125 the computing device may transmit, by the prediction module, an indication of the one or more predicted identifiers associated with the product tag category and an indication of a confidence level associated with each of the one or more predicted identifiers associated with the product tag category. The operations of 1125 may be performed according to the methods described herein. In certain examples, aspects of the operations of 1125 may be performed by a transmission component as described with reference to FIGS. 5 through 7.

At 1130 the computing device may display, at the user interface of the computing device, the one or more predicted identifiers associated with the product tag category and the indication of the confidence level associated with each of the one or more predicted identifiers associated with the product tag category. The operations of 1130 may be performed according to the methods described herein. In certain examples, aspects of the operations of 1130 may be performed by a display component as described with reference to FIGS. 5 through 7.

At 1135 the computing device may assign, at the user interface of the computing device, one predicted identifier of the one or more predicted identifiers associated with the product tag category to the work item. The operations of 1135 may be performed according to the methods described herein. In certain examples, aspects of the operations of 1135 may be performed by an assignment component as described with reference to FIGS. 5 through 7.

A method for predicting a category identifier for a work item is described. The method may include receiving, via a user interface of a computing device, a text description of the work item, an identifier associated with a team category, and an identifier associated with a product tag category. In some examples, the method may include transmitting a prediction request to a prediction module, wherein the prediction request comprises at least an indication of the text description of the work item. In other examples, the method may include inputting, by the prediction module, at least the indication of the text description of the work item into a prediction model of a plurality of prediction models. Additionally or alternatively, for example, the method may include determining, from the prediction model and based at least in part on the indication of the text description of the work item, one or more predicted identifiers associated with the product tag category, wherein the one or more predicted identifiers associated with the product tag category are different than the received identifier associated with the product tag category. In some examples, the method may include transmitting, by the prediction module, an indication of the one or more predicted identifiers associated with the product tag category and an indication of a confidence level associated with each of the one or more predicted identifiers associated with the product tag category. In other examples, the method may include displaying, at the user interface of the computing device, the one or more predicted identifiers associated with the product tag category and the indication of the confidence level associated with each of the one or more predicted identifiers associated with the product tag category.

An apparatus for predicting a category identifier for a work item is described. The apparatus may include a processor, memory in electronic communication with the processor, and instructions stored in the memory. The instructions may be executable to cause the processor to receive, via a user interface of a computing device, a text description of the work item, an identifier associated with a team category, and an identifier associated with a product tag category. In some examples the instructions may be operable to cause the processor to transmit a prediction request to a prediction module, wherein the prediction request comprises at least an indication of the text description of the work item. In other examples the instructions may be operable to cause the processor to input, by the prediction module, at least the indication of the text description of the work item into a prediction model of a plurality of prediction models. Additionally or alternatively, for example, the instructions may be operable to cause the processor to determine, from the prediction model and based at least in part on the indication of the text description of the work item, one or more predicted identifiers associated with the product tag category, wherein the one or more predicted identifiers associated with the product tag category are different than the received identifier associated with the product tag category. In some examples the instructions may be operable to cause the processor to transmit, by the prediction module, an indication of the one or more predicted identifiers associated with the product tag category and an indication of a confidence level associated with each of the one or more predicted identifiers associated with the product tag category. In other examples the instructions may be operable to cause the processor to display, at the user interface of the computing device, the one or more predicted identifiers associated with the product tag category and the indication of the confidence level associated with each of the one or more predicted identifiers associated with the product tag category.

A non-transitory computer-readable medium for predicting a category identifier for a work item is described. The non-transitory computer-readable medium may include instructions operable to cause a processor to receive, via a user interface of a computing device, a text description of the work item, an identifier associated with a team category, and an identifier associated with a product tag category. In some examples the instructions may be operable to cause the processor to transmit a prediction request to a prediction module, wherein the prediction request comprises at least an indication of the text description of the work item. In other examples, the instructions may be operable to cause the processor to input, by the prediction module, at least the indication of the text description of the work item into a prediction model of a plurality of prediction models. Additionally or alternatively, for example, the instructions may be operable to cause the processor to determine, from the prediction model and based at least in part on the indication of the text description of the work item, one or more predicted identifiers associated with the product tag category, wherein the one or more predicted identifiers associated with the product tag category are different than the received identifier associated with the product tag category. In some examples, the instructions may be operable to cause the processor to transmit, by the prediction module, an indication of the one or more predicted identifiers associated with the product tag category and an indication of a confidence level associated with each of the one or more predicted identifiers associated with the product tag category. In other examples, the instructions may be operable to cause the processor to display, at the user interface of the computing device, the one or more predicted identifiers associated with the product tag category and the indication of the confidence level associated with each of the one or more predicted identifiers associated with the product tag category.

Some examples of the method, apparatus, and non-transitory computer-readable medium described above may further include processes, features, means, or instructions for indicating a prediction model identifier in the prediction request, wherein the prediction model identifier identifies a particular prediction model from the plurality of prediction models.

In some examples of the method, apparatus, and non-transitory computer-readable medium described above, the prediction model identifier may identify a particular prediction model based at least in part on the received identifier associated with the team category.

Some examples of the method, apparatus, and non-transitory computer-readable medium described above may further include processes, features, means, or instructions for receiving, via the user interface of the computing device, an indication of confidence associated with the received identifier associated with the team category, wherein indicating the prediction model identifier may be based at least in part on the received indication of confidence. In some examples of the method, apparatus, and non-transitory computer-readable medium described above, each of the plurality of prediction models may be associated with a different identifier associated with the team category. In other examples of the method, apparatus, and non-transitory computer-readable medium described above, the prediction request may further comprise the identifier associated with the team category.

Some examples of the method, apparatus, and non-transitory computer-readable medium described above may further include processes, features, means, or instructions for inputting, by the prediction module, the identifier associated with the team category, wherein determining the one or more predicted identifiers may be based at least in part on the identifier associated with the team category. Other examples of the method, apparatus, and non-transitory computer-readable medium described above may further include processes, features, means, or instructions for assigning, at the user interface of the computing device, one predicted identifier of the one or more predicted identifiers associated with the product tag category to the work item. Some examples of the method, apparatus, and non-transitory computer-readable medium described above may further include processes, features, means, or instructions for transmitting the indication of the one or more predicted identifiers associated with the product tag category based at least in part on the confidence level associated with each of the one or more predicted identifiers.

In some examples of the method, apparatus, and non-transitory computer-readable medium described above, the text description of the work item may be associated with one or more of an investigation, a bug, or a task. In other examples of the method, apparatus, and non-transitory computer-readable medium described above, the identifier associated with the product tag category may comprise one or more of a keyword, a key phrase, or a category associated with a plurality of work items.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for predicting a category identifier for a work item, comprising:
receiving, via a user interface of a computing device, a text description of the work item, an identifier associated with a team category, and an identifier associated with a product tag category;
transmitting a prediction request to a prediction module, wherein the prediction request comprises at least an indication of the text description of the work item;
inputting, by the prediction module, at least the indication of the text description of the work item into a prediction model of a plurality of prediction models;
determining, from the prediction model and based at least in part on the indication of the text description of the work item, one or more predicted identifiers associated with the product tag category, wherein the one or more predicted identifiers associated with the product tag category are different than the received identifier associated with the product tag category;
transmitting, by the prediction module, an indication of the one or more predicted identifiers associated with the product tag category and an indication of a confidence level associated with each of the one or more predicted identifiers associated with the product tag category; and
displaying, at the user interface of the computing device, the one or more predicted identifiers associated with the product tag category and the indication of the confidence level associated with each of the one or more predicted identifiers associated with the product tag category.

2. The method of claim 1, further comprising:
indicating a prediction model identifier in the prediction request, wherein the prediction model identifier identifies a particular prediction model from the plurality of prediction models.

3. The method of claim 2, wherein the prediction model identifier identifies a particular prediction model based at least in part on the received identifier associated with the team category.

4. The method of claim 2, further comprising:
receiving, via the user interface of the computing device, an indication of confidence associated with the received identifier associated with the team category, wherein indicating the prediction model identifier is based at least in part on the received indication of confidence.

5. The method of claim 2, wherein each of the plurality of prediction models is associated with a different identifier associated with the team category.

6. The method of claim 1, wherein the prediction request further comprises the identifier associated with the team category.

7. The method of claim 6, further comprising:
inputting, by the prediction module, the identifier associated with the team category, wherein determining the one or more predicted identifiers is based at least in part on the identifier associated with the team category.

8. The method of claim 1, further comprising:
assigning, at the user interface of the computing device, one predicted identifier of the one or more predicted identifiers associated with the product tag category to the work item.

9. The method of claim 1, further comprising:
transmitting the indication of the one or more predicted identifiers associated with the product tag category is based at least in part on the confidence level associated with each of the one or more predicted identifiers.

10. The method of claim 1, wherein the text description of the work item is associated with one or more of an investigation, a bug, or a task.

11. The method of claim 10, wherein the identifier associated with the product tag category comprises one or more of a keyword, a key phrase, or a category associated with a plurality of work items.

12. An apparatus for predicting a category identifier for a work item, comprising:
a processor;
memory in electronic communication with the processor; and
instructions stored in the memory and executable by the processor to cause the apparatus to:
receive, via a user interface of a computing device, a text description of the work item, an identifier associated with a team category, and an identifier associated with a product tag category;
transmit a prediction request to a prediction module, wherein the prediction request comprises at least an indication of the text description of the work item;
input, by the prediction module, at least the indication of the text description of the work item into a prediction model of a plurality of prediction models;
determine, from the prediction model and based at least in part on the indication of the text description of the work item, one or more predicted identifiers associated with the product tag category, wherein the one or more predicted identifiers associated with the product tag category are different than the received identifier associated with the product tag category;
transmit, by the prediction module, an indication of the one or more predicted identifiers associated with the product tag category and an indication of a confidence level associated with each of the one or more predicted identifiers associated with the product tag category; and
display, at the user interface of the computing device, the one or more predicted identifiers associated with the product tag category and the indication of the confidence level associated with each of the one or more predicted identifiers associated with the product tag category.

13. The apparatus of claim 12, wherein the instructions are further executable by the processor to cause the apparatus to:
indicate a prediction model identifier in the prediction request, wherein the prediction model identifier identifies a particular prediction model from the plurality of prediction models.

14. The apparatus of claim 12, wherein the prediction request further comprises the identifier associated with the team category.

15. The apparatus of claim 14, wherein the instructions are further executable by the processor to cause the apparatus to:
input, by the prediction module, the identifier associated with the team category, wherein determining the one or more predicted identifiers is based at least in part on the identifier associated with the team category.

16. The apparatus of claim 12, wherein the instructions are further executable by the processor to cause the apparatus to:
assign, at the user interface of the computing device, one predicted identifier of the one or more predicted identifiers associated with the product tag category to the work item.

17. A non-transitory computer-readable medium storing code for predicting a category identifier for a work item, the code comprising instructions executable by a processor to:
receive, via a user interface of a computing device, a text description of the work item, an identifier associated with a team category, and an identifier associated with a product tag category;
transmit a prediction request to a prediction module, wherein the prediction request comprises at least an indication of the text description of the work item;
input, by the prediction module, at least the indication of the text description of the work item into a prediction model of a plurality of prediction models;
determine, from the prediction model and based at least in part on the indication of the text description of the work item, one or more predicted identifiers associated with the product tag category, wherein the one or more predicted identifiers associated with the product tag category are different than the received identifier associated with the product tag category;
transmit, by the prediction module, an indication of the one or more predicted identifiers associated with the product tag category and an indication of a confidence level associated with each of the one or more predicted identifiers associated with the product tag category; and
display, at the user interface of the computing device, the one or more predicted identifiers associated with the product tag category and the indication of the confidence level associated with each of the one or more predicted identifiers associated with the product tag category.

18. The non-transitory computer-readable medium of claim 17, wherein the instructions are further executable by the processor to:
indicate a prediction model identifier in the prediction request, wherein the prediction model identifier identifies a particular prediction model from the plurality of prediction models.

19. The non-transitory computer-readable medium of claim 17, wherein the prediction request further comprises the identifier associated with the team category.

20. The non-transitory computer-readable medium of claim 19, wherein the instructions are further executable by the processor to:
input, by the prediction module, the identifier associated with the team category, wherein determining the one or more predicted identifiers is based at least in part on the identifier associated with the team category.
